(19) United States
(12) Patent Application Publication
(10) Pub. No.: US 2025/0341003 A1
(43) Pub. Date: Nov. 6, 2025

(54) METHOD FOR GENERATING GAS MIXTURES COMPRISING CARBON MONOXIDE AND CARBON DIOXIDE FOR USE IN SYNTHESIS REACTIONS

(71) Applicant: HALDOR TOPSØE A/S, Kgs. Lyngby (DK)

(72) Inventors: Niels Christian SCHJØDT, Hvalsø (DK); Rainer KÜNGAS, Copenhagen (DK); Berit HINNEMANN, Stenløse (DK); Bengt Peter Gustav BLENNOW, Humlebæk (DK)

(73) Assignee: HALDOR TOPSØE A/S, Kgs. Lyngby (DK)

(21) Appl. No.: 19/268,547

(22) Filed: Jul. 14, 2025

Related U.S. Application Data
(63) Continuation of application No. 17/046,050, filed on Oct. 8, 2020.

(30) Foreign Application Priority Data
Apr. 13, 2018 (DK) PA 2018 00155

(51) Int. Cl. C25B 1/04; B01D 5/00; B01D 53/00; B01D 53/26; C01B 3/06; C01B 32/40; C10K 1/04; C10K 3/02; C25B 1/042; C25B 1/23; C25B 9/19; C25B 9/70; C25B 13/05; C25B 13/07; C25B 15/08

(52) U.S. Cl. CPC C25B 1/04; B01D 5/00; B01D 53/002; B01D 53/265; C01B 3/06; C01B 32/40; C10K 1/04; C10K 3/026; C25B 1/042; C25B 1/23; C25B 9/19; C25B 9/70; C25B 13/05; C25B 13/07; C25B 15/08; C25B 15/081; C25B 15/083; B01D 2257/80; C01B 2203/02; C01B 2203/0495; C01B 2203/06; C01B 2203/12

(57) ABSTRACT

A method for the generation of a gas mixture including carbon monoxide, carbon dioxide and optionally hydrogen for use in hydroformylation plants or in carbonylation plants, including mixing an optional steam with carbon dioxide in the desired molar ratio, feeding the resulting gas to a solid oxide electrolysis cell (SOEC) or an SOEC stack at a sufficient temperature for the cell or cell stack to operate while effecting a partial conversion of carbon dioxide to carbon monoxide and optionally of steam to hydrogen, removing some or all the remaining steam from the raw product gas stream by cooling the raw product gas stream and separating the remaining product gas from a liquid, and using the gas mixture containing CO and CO₂ for liquid phase synthesis reactions utilizing carbon monoxide as one of the reactants while recycling CO₂ to the SOEC or SOEC stack.

### CROSS-REFERENCE TO RELATED APPLICATIONS

This application is a continuation application of U.S. application Ser. No. 17/046,050, filed on Oct. 8, 2020, which is a U.S. National Stage of International Application No. PCT/EP2019/059204, filed on Apr. 11, 2019, which claims priority to Danish Application No. PA 2018 00155, filed on Apr. 13, 2018. The entire contents of each of U.S. application Ser. No. 17/046,050, International Application No. PCT/EP2019/059204, and Danish Application No. PA 2018 00155 are hereby incorporated herein by reference in their entirety.

### TECHNICAL FIELD

The present invention relates to a method for generating gas mixtures comprising carbon monoxide and carbon dioxide and their use in synthesis reactions, especially hydroformylation and carbonylation reactions.

### BACKGROUND

Carbon monoxide has a rich chemistry which has found many uses within the chemical industry (see e.g. R. A. Sheldon (ed.), “Chemicals from Synthesis Gas”, Reidel/Kluwer Dordrecht (1983)). Thus, several chemicals are produced with CO as one of the reactants, and such reactions are termed carbonylation reactions. Some carbonylation processes, such as methanol synthesis, rely on gas phase conversion. In many cases, however, the carbonylation reaction is performed in a liquid phase. Thus, methanol carbonylation to acetic acid or acetic anhydride, hydroformylation of alkenes to aldehydes and/or alcohols and Reppe carbonylations of alkynes or alkenes to carboxylic acids and derivatives thereof are all conducted in a liquid phase pressurized with a carbon monoxide containing gas. The present invention relates to such liquid phase carbonylation processes.

Regarding the hydroformylation reaction, it has been shown that the rate may be increased up to four-fold if the reaction is conducted in so-called CXL (CO₂-expanded liquid) media (see e.g. H. Jin & B. Subramaniam, Chemical Engineering Science 59 (2004) 4887-4893 and H. Jin et al., AlChE Journal 52 (2006) 2575-2581). Pressurizing an organic solvent with CO₂ makes the solvent expand, and the diffusivity and solubility of other (reactant) gases are increased compared to the neat solvent. The use of CXL media is a general way of intensifying liquid phase catalytic reactions, such as carbonylations. However, a source of CO₂ as well as a source of CO (and a source of H₂ in the case of hydroformylation) need to be provided, which is not always feasible and under all circumstances will increase the complexity of the front-end.

A sustainable source of CO is CO₂. By means of a solid oxide electrolysis cell (SOEC) or an SOEC stack, CO₂ can be electrolyzed to CO. Furthermore, using the same SOEC or SOEC stack, H₂ can be generated from H₂O. One limitation, however, is that the SOEC cannot operate at full conversion due to heavy formation of carbon or carbonaceous compounds in the cell. If pure CO (or CO/H₂) is desired, it is necessary to separate the unconverted CO₂, e.g. by means of a pressure swing adsorption (PSA) unit. However, a PSA unit is expensive and adds substantially to the cost of the entire process.

### SUMMARY

Now it has turned out that, by the present invention, these problems combined can be turned into an advantage. Using CO₂ (and optionally H₂O) as feed for an SOEC or SOEC stack operating at moderate (e.g. 25%) conversion, a stream of CO (and optionally H₂) in CO₂ is obtained, which can be used as the gaseous feed for catalyzed liquid phase carbonylation reactions, such as e.g. alcohol carbonylation, hydroformylation, Reppe carbonylations and Koch carbonylations. Thus, carbon dioxide will serve as the sole source of carbon monoxide, and any storage, transportation and handling thereof will be omitted. Furthermore, the presence of carbon dioxide in the reaction medium will provide the conditions for CXL, which will increase the reaction rate of the carbonylation reaction.

In the following, the hydroformylation reaction is used as an example to illustrate the invention.

Hydroformylation, also known as “oxo synthesis” or “oxo process”, is an industrial process for the production of aldehydes from alkenes. More specifically, the hydroformylation reaction is the addition of carbon monoxide (CO) and hydrogen (H₂) to an alkene. This chemical reaction entails the net addition of a formyl group (CHO) and a hydrogen atom to a carbon-carbon double bond. The reaction yields an aldehyde with a carbon chain one unit longer than that of the parent alkene. If the aldehyde is the desired product, then the syngas should have a composition close to CO:H₂=1:1.

In some cases, the alcohol corresponding to the aldehyde is the desired product. When this is the case, more hydrogen is consumed to reduce the intermediate aldehyde to an alcohol, and therefore the syngas should have a composition of approximately CO:H₂=1:2.

Sometimes it is desired to purify the intermediate aldehyde before converting it into an alcohol. Accordingly, in such case, a syngas with the composition CO:H₂=1:1 must first be used, followed by pure H₂.

Thus, the need for low-module syngas (i.e. low hydrogen-to-carbon monoxide ratio) is characteristic for the hydroformylation reaction. Such a syngas composition is rather costly to provide since it cannot be obtained directly from steam reforming of natural gas or naphtha. At least a steam reformed gas must undergo reverse shift, i.e. the reaction CO₂+H₂->CO+H₂O, to provide sufficient CO. Otherwise, a cold box for condensing CO has to be installed to separate the CO. This is also a costly solution, and there will be an excess of hydrogen, for which a purpose for use has to be found.

Alternatively, gasification plants may provide low-module (i.e. CO-rich) syngas, but gasification plants need to be very large in order to be efficient, and they are also expensive, both with respect to CAPEX and to OPEX. Furthermore, coal-based gasification plants are increasingly undesired due to the substantial environmental implications and a large CO₂ footprint.

Low-module syngas for hydroformylation is therefore generally costly. Large hydroformylation plants are often placed in industrial areas and may thus obtain the necessary syngas “over the fence” from a nearby syngas producer. In many cases, however, this is not possible for medium or small size hydroformylation plants. Instead, such smaller plants will need to import the syngas, e.g. in gas cylinders, which is very expensive. Furthermore, transportation and handling of such gas containers is connected with certain elements of risk since syngas (not least low-module syngas) is highly toxic and extremely flammable, and syngas may form explosive mixtures with air. Import of CO by tube trailers will face similar challenges, both in terms of costs and in terms of safety.

Regarding prior art, U.S. Pat. No. 8,568,581 discloses a hydroformylation process using a traditional electrochemical cell, not a solid oxide electrolysis cell (SOEC) or an SOEC stack, for preparation of the synthesis gas to be used in the process. Water is introduced in a first (anode) compartment of the cell, and CO₂ is introduced into the second (cathode) compartment of the cell followed by alkene and catalyst addition to the cell, and the cathode induces liquid phase hydroformylation when an electrical potential is applied between the anode and the cathode.

In WO 2017/014635, a method for electrochemically reducing carbon dioxide is described. The method involves the conversion of CO₂ into one or more platform molecules such as syngas, alkenes, alcohols (including diols), aldehydes, ketones and carboxylic acids, and also conversion of CO₂ into i.a. CO, hydrogen and syngas. The method does not, however, include preparation of low-module syngas for hydroformylation.

US 2014/0291162 discloses a multi-step method for preparation of various compounds, such as aldehydes, by electrolysis of previously prepared CO₂ and/or CO and steam. The method includes i.a. heat transfer from a heating means towards a proton-conductive electrolyser comprising a proton-conducting membrane arranged between the anode and the cathode.

Applicant's WO 2013/164172 describes a process for the production of a chemical compound from a feed stream containing CO₂, the process comprising the steps of:
electrolyzing at least a part of the CO₂ in a solid oxide electrolysis cell (SOEC) to a first gas stream containing CO and a second gas stream containing 02,
adjusting the composition of the first gas stream or the second gas stream or both gas streams to include CO₂, either by operating at less than full conversion of CO₂ or by sweeping one or both gas streams with a gas containing CO₂ or by—at some stage between the electrolysis cell and the oxidative carbonylation reactor—diluting one or both gas streams with a gas containing CO₂, and
introducing the first and second process stream into a reaction stage and reacting the first and second process stream combined or in succession with a substrate to the chemical compound by means of an oxidative carbonylation reaction with the CO and the O₂ contained in the process feed stream.

The invention described in WO 2013/164172 is thus based on the utilization of a combination of the two electrolysis streams (the CO-containing stream and the O₂-containing stream) for oxidative carbonylation reactions, while the present invention teaches how to obtain a suitable CO-containing stream by electrolysis to be used as one of the feed streams in carbonylation reactions.

Finally, US 2011/0253550 discloses a method for producing a synthetic material, where water is converted into H₂ and O₂ using high-temperature electrolysis. Depending on the way the catalytic process is carried out, the mixture of water vapor, CO₂ and H₂ can additionally be converted catalytically into functionalized hydrocarbons, such as aldehydes. This publication is very unspecific and does not define the concept of high-temperature electrolysis, neither in terms of temperature range nor in terms of the kind(s) of equipment being usable for the purpose.

### DETAILED DESCRIPTION

Now it has turned out that the above-described elements of risk in relation to syngas can effectively be counteracted by generating the syngas, which is necessary for hydroformylation plants, in an apparatus based on solid oxide electrolysis cells (SOECs) or SOEC stacks. A solid oxide electrolysis cell is a solid oxide fuel cell (SOFC) run in reverse mode, which uses a solid oxide electrolyte to produce e.g. oxygen and hydrogen gas by electrolysis of water. Importantly, it can also be used for converting CO₂ electrochemically into the toxic, but for many reasons attractive CO directly at the site where the CO is to be used, which is an absolute advantage. The turn-on/turn-off of the apparatus is very swift, which is a further advantage.

Thus, co-electrolysis of water and carbon dioxide in an SOEC stack may produce a mixture of hydrogen and carbon monoxide in the desired ratio. If hydrogen is already available from other sources, then the SOEC may be used to generate carbon monoxide. This includes the option of preparing H₂ and CO in separate SOEC stacks. In practice it is usually desirable to operate the SOEC stack at less than full conversion and therefore the product gas will contain CO, CO₂ and optionally H₂ and H₂O. By cooling the raw product gas, most of the steam (if present) will condense, and it can then be separated from the gas stream as liquid water in a separator. The product gas may be further dried, e.g. over a drying column, if desired. The product gas will then contain CO, CO₂ and optionally H₂ as the main components. The separation of CO₂ from the reactive components CO and H₂ is more complicated and costly than the separation of water from the product gas. It can be done by using a PSA (pressure swing adsorption) unit, which unfortunately is quite expensive. However, the presence of CO₂ in the hydroformylation reaction actually is an advantage: The hydroformylation reaction is carried out in a liquid medium, and pressurizing this liquid with CO₂ entails a CO₂-expanded liquid (CXL) as defined above. It has been described in the literature (see Fang et al., Ind. Eng. Chem. Res. 46 (2007) 8687-8692 and references therein) that CXL media alleviate mass transfer limitations in the hydroformylation reaction and increase the solubility of the reactant gases in the CXL medium compared to the neat liquid medium. As a result of this, the rate of the hydroformylation reaction may be increased by up to a factor of four in CXL-media compared to neat organic solvents. Furthermore, the n/iso ratio, i.e. the ratio between linear and branched aldehydes, may be improved by using a CXL solvent compared to using the neat solvent as taught in U.S. Pat. No. 7,365,234 B2.

Therefore, the present invention offers a way to provide a syngas with the appropriate H₂/CO ratio while at the same time providing the CO₂ needed for obtaining a CO₂-expanded liquid reaction medium for the hydroformylation process. If hydrogen is available from other sources, the present invention offers a way to provide a CO/CO₂-mixture which, when mixed with hydrogen, is suitable for carrying out the hydroformylation reaction in a CXL medium.

An example of an olefin used for the hydroformylation reaction is 1-octene, but in principle any olefin may be used according to the present invention. An example of a liquid solvent for the hydroformylation reaction is acetone, but a long range of other organic solvents may be used.

Many other catalyzed liquid-phase carbonylation processes are used industrially, and the present invention can be applied to all of them.

So it is the intention of the present invention to provide an apparatus generating syngas or a mixture of carbon oxides based on solid oxide electrolysis cells, which can generate syngas for hydroformylation plants or other plants which are based on synthesis with CO in the liquid phase. The raw materials for generating the syngas will be mixtures of CO₂ and optionally H₂O.

A solid oxide electrolysis cell system comprises an SOEC core, wherein the SOEC stack is housed together with inlets and outlets for process gases. The feed gas or “fuel gas” is led to the cathode part of the stack, from where the product gas from the electrolysis is taken out. The anode part of the stack is also called the oxygen side, because oxygen is produced on this side. In the stack, CO and H₂ are produced from a mixture of CO₂ and water, which is led to the fuel side of the stack with an applied current, and excess oxygen is transported to the oxygen side of the stack, optionally using air, nitrogen or carbon dioxide to flush the oxygen side.

More specifically, the principle of producing CO and H₂ by using a solid oxide electrolysis cell system consists in leading CO₂ and H₂O to the fuel side of an SOEC with an applied current to convert CO₂ to CO and H₂O to H₂ and transport the oxygen surplus to the oxygen side of the SOEC. Air, nitrogen or carbon dioxide may be used to flush the oxygen side. Flushing the oxygen side of the SOEC has two advantages, more specifically (1) reducing the oxygen concentration and related corrosive effects and (2) providing means for feeding energy into the SOEC, operating it endothermic. The product stream from the SOEC contains a mixture of CO, H₂, H₂O and CO₂, which—after removal of water, e.g. by condensation—can be used directly in the hydroformylation reaction.

In one embodiment of the invention, CO and H₂ are both made by electrolysis, but in separate SOECs or SOEC stacks. This has the advantage that each SOEC or SOEC stack may be optimized for its specific use.

The present invention pertains not only to the hydroformylation reaction, but in principle to all catalyzed liquid phase reactions where CO is one of the reactant chemicals.

The overall principle in the production of CO by electrolysis is that CO₂ (possibly including some CO) is fed to the cathode. As current is applied to the stack, CO₂ is converted to CO to provide an output stream with a high concentration of CO:

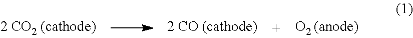

If pure CO₂ is fed into the SOEC stack, the output will be CO (converted from CO₂) and unconverted CO₂.

If a mixture of CO₂ and H₂O is fed into the SOEC stack, the output will be a mixture of CO, CO₂, H₂O and H₂. In addition to the electrochemical conversion reaction of CO₂ to CO (1) given above, steam will be electrochemically converted into gaseous hydrogen according to the following reaction:

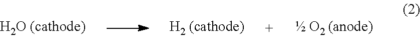

Additionally, a non-electrochemical process, namely the reverse water gas shift (RWGS) reaction, takes place within the pores of the cathode:

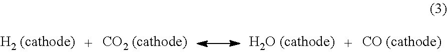

In state-of-the-art SOEC stacks, where the cathode comprises Ni metal (typically a cermet of Ni and stabilized zirconia), the overpotential for reaction (1) is typically significantly higher than that for reaction (2). Furthermore, since Ni is a good catalyst for the RWGS reaction, reaction (3) occurs almost instantaneously at SOEC operating temperatures. In other words, the vast majority of the electrolysis current is used for converting H₂O into H₂ (reaction 2), and the produced H₂ rapidly reacts with CO₂ (according to reaction 3) to provide a mixture of CO, CO₂, H₂O and H₂. Under typical SOEC operating conditions, only a very small amount of CO is produced directly via electrochemical conversion of CO₂ into CO (reaction 1).

In case pure H₂O is fed into the SOEC stack, the conversion X_{H2O} of H₂O to H₂ is given by Faraday's law of electrolysis:

$${X}_{\text{?}} = \frac{{p}_{\text{?}}}{{p}_{\text{?}} + {p}_{\text{?}}} = \frac{i \cdot {V}_{\text{?}} \cdot {n}_{\text{?}}}{z \cdot {f}_{\text{?}} \cdot F} \qquad ( 4 )$$

$$\text{?} \text{indicates text missing or illegible when filed}$$

where p_{H2} is the partial pressure of H₂ at cathode outlet, p_{H2O} is the partial pressure of steam at cathode outlet, i is the electrolysis current, Vₘ is the molar volume of gas at standard temperature and pressure, n_{cells} is the number of cells in an SOEC stack, z is the number of electrons transferred in the electrochemical reaction, f_{H2O} is the flow of gaseous steam into the stack (at standard temperature and pressure), and F is Faraday's constant.

In case pure CO₂ is fed into the SOEC stack, the conversion X_{CO2} of CO₂ to CO is given by an analogous expression:

$${X}_{\text{?}} = \frac{{p}_{\text{?}}}{{p}_{\text{?}} + {p}_{\text{?}}} = \frac{i \cdot {V}_{\text{?}} \cdot {n}_{\text{?}}}{z \cdot {f}_{\text{?}} \cdot F} \qquad ( 5 )$$

$$\text{?} \text{indicates text missing or illegible when filed}$$

where p_{CO} is the partial pressure of CO at cathode outlet, p_{CO2} is the partial pressure of CO₂ at cathode outlet, i is the electrolysis current, Vₘ is the molar volume of gas at standard temperature and pressure, n_{cells} is the number of cells in an SOEC stack, z is the number of electrons transferred in the electrochemical reaction, f_{CO2} is the flow of gaseous CO₂ into the stack (at standard temperature and pressure), and F is Faraday's constant.

In case both steam and CO₂ is fed into the SOEC stack, the gas composition exiting the stack will further be affected by the RWGS reaction (3). The equilibrium constant for RWGS reaction, K_{RWGS}, is given by:

$${K}_{\text{?}} = \frac{{p}_{\text{?}} \cdot {p}_{\text{?}}}{{p}_{\text{?}} \cdot {p}_{\text{?}}} = exp ( - \frac{Δ G}{RT} ) \qquad ( 6 )$$

$$\text{?} \text{indicates text missing or illegible when filed}$$

where ΔG is the Gibbs free energy of the reaction at SOEC operating temperature, R is the universal gas constant, and T is the absolute temperature.

The equilibrium constant, and therefore the extent to which electrochemically produced H₂ is used to convert CO₂ into CO, is temperature-dependent. For example, at 500° C., K_{RWGS}=0.195. At 600° C., K_{RWGS}=0.374. At 700° C., K_{RWGS}=0.619.

Thus, the present invention relates to a method for the generation of a gas mixture comprising carbon monoxide, carbon dioxide and optionally hydrogen for use in hydroformylation plants or in carbonylation plants, comprising the steps of:
optionally evaporating water to steam,
mixing the optional steam with carbon dioxide in the desired molar ratio, and
feeding the resulting gas to a solid oxide electrolysis cell (SOEC) or an SOEC stack at a sufficient temperature for the cell or cell stack to operate while supplying an electrical current to the cell or cell stack to effect a partial conversion of carbon dioxide to carbon monoxide and optionally of steam to hydrogen, wherein
optionally some of or all the remaining steam is removed from the raw product gas stream by cooling the raw product gas stream allowing for condensation of at least part of the steam as liquid water and separating the remaining product gas from the liquid, and
the gas mixture containing CO and CO₂ is used for liquid phase synthesis reactions, utilizing carbon monoxide as one of the reactants while recycling CO₂ to the SOEC.

For use in the hydroformylation reaction, the molar ratio between steam and carbon dioxide is preferably in the interval 0-2, more preferably in the interval 0-1.5 and most preferably in the interval 0-1, since this ratio will provide a syngas with a CO:H₂ ratio of 1.015:1 (see Example 4 below).

Preferably the temperature, at which CO is produced by electrolysis of CO₂ in the SOEC or SOEC stack, is around 700° C.

One of the great advantages of the method of the present invention is that the syngas can be generated with the use of virtually any desired CO/H₂ ratio, since this is simply a matter of adjusting the CO₂/H₂O ratio of the feed gas.

Another great advantage of the invention is, as already mentioned, that the syngas can be generated “on-site”, i.e. exactly where it is intended to be used, instead of having to transport the toxic and highly flammable syngas from the preparation site to the site of use.

Yet another advantage of the present invention is that if it is desired to switch between a CO:H₂=1:1 syngas and pure H₂, this can be done using the same apparatus, simply by adjusting the feed from CO₂/H₂O to pure H₂O.

A further advantage of the present invention is that it provides a CO/H₂ stream diluted in CO₂, which enables the subsequent hydroformylation reaction to be carried out in a CO₂-expanded liquid (CXL) reaction medium. This advantage embraces higher reaction rates, improved selectivity (n/iso ratio) at mild conditions (lower temperature and lower pressure) compared to hydroformylation in neat liquid media. Similar advantages in other carbonylation reactions are to be expected.

A still further advantage of the present invention is that syngas of high purity can be produced without being more expensive than normal syngas in any way, even though this desired high purity would prima facie be expected to entail increasing production costs. This is because the purity of the syngas is largely determined by the purity of the CO₂/H₂O feed, and provided that a feed consisting of food grade or beverage grade CO₂ and ion-exchanged water is chosen, very pure syngas can be produced.

The invention is illustrated further in the examples which follow.

### Example 1

### CO₂ Electrolysis

An SOEC stack consisting of 75 cells is operated at an average temperature of 700° C. with pure CO₂ being fed to the cathode at a flow rate of 100 Nl/min CO₂, while applying an electrolysis current of 50 A. Based on equation (5) above, the conversion of CO₂ under such conditions is 26%, i.e. the gas exiting the cathode side of the stack consists of 26% CO and 74% CO₂.

### Example 2

### H₂O Electrolysis

An SOEC stack consisting of 75 cells is operated at an average temperature of 700° C. with pure steam being fed to the cathode at a flow rate of 100 NI/min steam (corresponding to a liquid water flow rate of approximately 80 g/min), while applying an electrolysis current of 50 A. Based on equation (4) above, the conversion of H₂O under such conditions is 26%, i.e. the gas exiting the cathode side of the stack consists of 26% H₂ and 74% H₂O.

### Example 3

### Co-Electrolysis

An SOEC stack, consisting of 75 cells, is operated at an average temperature of 700° C. with a mixture of steam and CO₂ being fed to the cathode in a molar ratio of 1:1 with a total flow rate of 100 Nl/min, while applying an electrolysis current of 50 A. In the stack, steam is electrochemically converted into H₂ according to reaction (2) above. Assuming that Pelectrochemical conversion of CO₂ via reaction (1) is negligible, 52% of the fed steam is electrochemically converted into hydrogen. Were the RWGS reaction not present, the gas exiting the stack would have the following composition: 0% CO, 50% CO₂, 26% H₂ and 24% H₂O. However, due to the RWGS reaction, some of the produced hydrogen will be used to generate CO. Therefore, the gas exiting the stack will actually have the following composition: 10.7% CO, 39.3% CO₂, 15.3% H₂ and 34.7% H₂O. The ratio of CO:H₂ in the product gas is thus 1:1.43.

### Example 4

### Co-Electrolysis

An SOEC stack consisting of 75 cells is operated at an average temperature of 700° C. with a mixture of steam and CO₂ being fed to the cathode in a molar ratio of 41:59 with a total flow rate of 100 Nl/min, while applying an electrolysis current of 50 A. In the stack, steam is electrochemically converted into H₂ according to reaction (2) above. Assuming that electrochemical conversion of CO₂ via reaction (1) is negligible, 64% of the fed steam is electrochemically converted into hydrogen. Were the RWGS reaction not present, the gas exiting the stack would have the following composition: 0% CO, 59% CO₂, 26% H₂ and 15% H₂O. However, due to the RWGS reaction, some of the produced hydrogen will be used to generate CO. Therefore, the gas exiting the stack will actually have the following composition: 13.2% CO, 45.8% CO₂, 13.0% H₂ and 28.0% H₂O. The ratio of CO:H₂ in the product gas is thus 1.015:1.

1. A method for the generation of a gas mixture comprising carbon monoxide, carbon dioxide, and hydrogen for use in a liquid phase hydroformylation or a liquid phase carbonylation, comprising the steps of:
mixing steam with carbon dioxide in a desired molar ratio to form a resulting gas;
feeding the resulting gas to a solid oxide electrolysis cell (SOEC) or an SOEC stack at a sufficient temperature for the SOEC or SOEC stack to operate while supplying an electrical current to the SOEC or SOEC stack to effect a partial conversion of carbon dioxide to carbon monoxide and of steam to hydrogen forming a raw product gas comprising carbon monoxide and carbon dioxide;
removing some of or all remaining steam from the raw product gas by cooling the raw product gas allowing for condensation of at least part of the steam as liquid water and separating a remaining product gas comprising carbon monoxide and carbon dioxide from the liquid water; and
using the remaining product gas for the liquid phase hydroformylation or the liquid phase carbonylation, the liquid phase hydroformylation or the liquid phase carbonylation utilizing carbon monoxide as a reactant in the liquid phase hydroformylation or the liquid phase carbonylation, while utilizing at least some of the carbon dioxide to pressurize the liquid phase hydroformylation or the liquid phase carbonylation.

2. The method of claim 1, wherein utilizing at least some of the carbon dioxide to pressurize the liquid phase hydroformylation or the liquid phase carbonylation increases the reaction rate of the liquid hydroformylation reaction or the liquid phase carbonylation.

3. The method of claim 1, further comprising recycling at least some of the carbon dioxide remaining from after the liquid phase hydroformylation or the liquid phase carbonylation to the SOEC or SOEC stack.

4. The method of claim 1, comprising utilizing carbon monoxide and hydrogen as reactants in liquid phase hydroformylation.

5. The method of claim 1, wherein the liquid phase hydroformylation or the liquid phase carbonylation is liquid phase carbonylation.

6. The method of claim 1, comprising flushing an oxygen side of the SOEC or SOEC stack.

7. The method of claim 6, wherein the flushing is with air, nitrogen, steam, or carbon dioxide.

8. The method of claim 6, wherein the flushing reduces the oxygen concentration on the oxygen side of the SOEC or SOEC stack.

9. The method of claim 6, wherein the flushing feeds energy into the SOEC or SOEC stack allowing the SOEC or SOEC stack to operate endothermically.

10. The method of claim 1, comprising operating the SOEC or SOEC stack endothermically.

11. The method of claim 1, comprising utilizing at least some of the remaining product gas to pressurize the liquid phase hydroformylation or the liquid phase carbonylation.

12. A method for the generation of a gas mixture comprising carbon monoxide, carbon dioxide, and hydrogen for use in a liquid phase synthesis reaction, comprising the steps of:
mixing steam with carbon dioxide in a desired molar ratio to form a resulting gas;
feeding the resulting gas to a solid oxide electrolysis cell (SOEC) or an SOEC stack at a sufficient temperature for the SOEC or SOEC stack to operate while supplying an electrical current to the SOEC or SOEC stack to effect a partial conversion of carbon dioxide to carbon monoxide and of steam to hydrogen forming a raw product gas comprising carbon monoxide and carbon dioxide;
removing some of or all remaining steam from the raw product gas by cooling the raw product gas allowing for condensation of at least part of the steam as liquid water and separating a remaining product gas comprising carbon monoxide and carbon dioxide from the liquid water; and
using the remaining product gas for the liquid phase synthesis reaction, the liquid phase synthesis reaction utilizing carbon monoxide as a reactant in the liquid phase synthesis reaction, while utilizing at least some of the carbon dioxide to pressurize the liquid phase synthesis reaction.

13. The method of claim 12, further comprising recycling at least some of the carbon dioxide remaining from after the liquid phase synthesis reaction to the SOEC or SOEC stack.

14. The method of claim 12, comprising flushing an oxygen side of the SOEC or SOEC stack.

15. The method of claim 14, wherein the flushing is with air, nitrogen, steam, or carbon dioxide.

16. The method of claim 14, wherein the flushing reduces the oxygen concentration on the oxygen side of the SOEC or SOEC stack.

17. The method of claim 14, wherein the flushing feeds energy into the SOEC or SOEC stack allowing the SOEC or SOEC stack to operate endothermically.

18. A method for the generation of a gas mixture comprising carbon monoxide and carbon dioxide for use in a liquid phase hydroformylation or a liquid phase carbonylation, comprising the steps of:
feeding a gas comprising carbon dioxide to a solid oxide electrolysis cell (SOEC) or an SOEC stack at a sufficient temperature for the SOEC or SOEC stack to operate while supplying an electrical current to the SOEC or SOEC stack to effect a partial conversion of carbon dioxide to carbon monoxide forming a raw product gas comprising carbon monoxide and carbon dioxide;
using the raw product gas for the liquid phase hydroformylation or the liquid phase carbonylation, the liquid phase hydroformylation or the liquid phase carbonylation utilizing carbon monoxide as a reactant in the liquid phase hydroformylation or the liquid phase carbonylation, while utilizing at least some of the carbon dioxide to pressurize the liquid phase hydroformylation or the liquid phase carbonylation, which increases the reaction rate of the liquid hydroformylation reaction or the liquid phase carbonylation; and
recycling at least some of the carbon dioxide remaining from after the liquid phase hydroformylation or the liquid phase carbonylation to the SOEC or SOEC stack.
